(19) United States
(12) Patent Application Publication
(10) Pub. No.: US 2020/0173780 A1
(43) Pub. Date: Jun. 4, 2020

(54) GYROSCOPE, METHODS OF FORMING AND OPERATING THE SAME

(71) Applicant: Agency for Science, Technology and Research, Singapore (SG)

(72) Inventors: Guoqiang Wu, Singapore (SG); Jifang Tao, Singapore (SG); Alex Yuandong Gu, Singapore (SG); Geng Li Chua, Singapore (SG)

(21) Appl. No.: 16/638,082

(22) PCT Filed: Aug. 16, 2018
(86) PCT No.: PCT/SG2018/050415

§ 371 Date: Feb. 10, 2020

(30) Foreign Application Priority Data
Aug. 24, 2017 (SG) 10201706910R

(51) Int. Cl. G01C 19/5698

(52) U.S. Cl. CPC G01C 19/5698

(57) ABSTRACT

Various embodiments may provide a gyroscope. The gyroscope may include a piezoelectric substrate, an excitation transducer configured to generate a surface acoustic wave, and a sensing transducer configured to receive the surface acoustic wave generated by the excitation transducer. The gyroscope may additionally include a mass dot array between the excitation transducer and the sensing transducer, the mass dot array configured to generate a stress on the piezoelectric substrate based on a rotation of said gyroscope upon the surface acoustic wave passing through the mass dot array. The gyroscope may also include a light source, and an optical detector configured to receive one or more light beams generated by the light source to determine the rotation of the gyroscope based on a property of the one or more light beams. The property of the one or more light beams may be variable based on the stress on the piezoelectric substrate.

### CROSS-REFERENCE TO RELATED APPLICATION

This application claims the benefit of priority of Singapore application No. 1020170691OR filed on Aug. 24, 2017, the contents of it being hereby incorporated by reference in its entirety for all purposes.

### TECHNICAL FIELD

Various aspects of this disclosure may relate to a gyroscope. Various aspects of this disclosure may relate to a method of forming a gyroscope. Various aspects of this disclosure may relate to a method of operating a gyroscope.

### BACKGROUND

In recent years, the segment of microelectromechanical systems (MEMS) Coriolis gyroscopes is one of the fastest growing segments in the sensor market, compared with optic and ring laser gyroscopes. This may be due to the small size, promising performance, and low cost of the MEMS Coriolis gyroscopes. Two of the most important parameters for MEMS gyroscopes are resolution and anti-vibration or shock capability.

Mechanical vibrations in gyroscopes can create short term output errors and degrade performance. Such output errors have been observed in many devices, and the errors may be categorized as either false output or sensitivity change. The measure of the angular rate of a gyroscope should not be corrupted by linear acceleration, vibration, or shock. A high rejection of environmental noise may be required for the reliable operation of such devices.

FIG. 1 illustrates angular accelerations on a printed circuit board caused by vibrations.

### SUMMARY

Various embodiments may provide a gyroscope. The gyroscope may include a piezoelectric substrate. The gyroscope may also include an excitation transducer over the piezoelectric substrate, the excitation transducer configured to generate a surface acoustic wave. The gyroscope may further include a sensing transducer over the piezoelectric substrate, the sensing transducer configured to receive the surface acoustic wave generated by the excitation transducer. The gyroscope may additionally include a mass dot array over the piezoelectric substrate and between the excitation transducer and the sensing transducer, the mass dot array configured to generate a stress on the piezoelectric substrate based on a rotation of said gyroscope upon the surface acoustic wave passing through the mass dot array. The gyroscope may also include a light source. The gyroscope may further include an optical detector configured to receive one or more light beams generated by the light source to determine the rotation of the gyroscope based on a property of the one or more light beams. The property of the one or more light beams may be variable based on the stress on the piezoelectric substrate.

Various embodiments may provide a method of forming a gyroscope. The method may include forming an excitation transducer over or on a piezoelectric substrate, the excitation transducer configured to generate a surface acoustic wave. The method may also include forming a sensing transducer over or on the piezoelectric substrate, the sensing transducer configured to receive the surface acoustic wave generated by the excitation transducer. The method may additionally include forming a mass dot array over or on the piezoelectric substrate and between the excitation transducer and the sensing transducer, the mass dot array configured to generate a stress on the piezoelectric substrate based on a rotation of said gyroscope upon the surface acoustic wave passing through the mass dot array. The method may also include coupling an optical detector to a light source. The optical detector may be configured to receive one or more light beams generated by the light source to determine the rotation of the gyroscope based on a property of the one or more light beams. The property of the one or more light beams may be variable or changeable based on the stress on the piezoelectric substrate.

Various embodiments may provide a method of operating the gyroscope. The method may include using an excitation transducer, the excitation transducer over a piezoelectric transducer, to generate a surface acoustic wave so that the surface acoustic wave is received by a sensing transducer over the piezoelectric substrate. The surface acoustic wave may pass through a mass dot array, the mass dot array between the excitation transducer and the sensing transducer and over the piezoelectric substrate. The method may further include rotating the gyroscope so that the array generates a stress on the piezoelectric substrate based on said rotation of the gyroscope upon the surface acoustic wave passing through the mass dot array. The method may also include determining the rotation of the gyroscope based on a property of one or more light beams received by an optical detector over the piezoelectric substrate, the optical detector optically coupled to a light source over the piezoelectric substrate. The property of the one or more light beams may be variable or changeable based on the stress on the piezoelectric substrate.

### BRIEF DESCRIPTION OF THE DRAWINGS

The invention will be better understood with reference to the detailed description when considered in conjunction with the non-limiting examples and the accompanying drawings, in which:

FIG. 1 illustrates angular accelerations on a printed circuit board caused by vibrations.

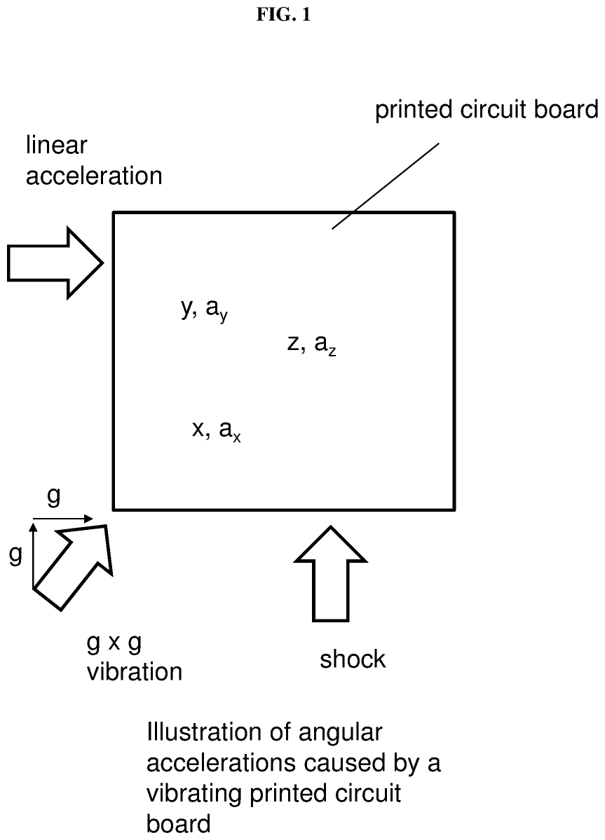

FIG. 2 shows a general illustration of the gyroscope according to various embodiments.

FIG. 3 shows a general illustration of a method of forming the gyroscope according to various embodiments.

FIG. 4 shows a general illustration of a method of operating the gyroscope according to various embodiments.

FIG. 5A shows a schematic of a gyroscope according to various embodiments.

FIG. 5B shows a diagram block of the gyroscope according to various embodiments.

FIG. 5C is a schematic illustrate the different signals generated by the gyroscope according to various embodiments.

FIG. 5D is a schematic illustrating the Coriolis force generated by a particle according to various embodiments.

FIG. 6 shows a schematic of a gyroscope 600 according to various other embodiments.

FIG. 7A is a plot of depth (in ×10⁻⁵ metres or m) as a function of (in ×10⁻⁵ in metres or m) showing the simulated standing mode shape of the gyroscope according to various embodiments.

FIG. 7B is a plot of impedance (in ohms) as a function of frequency (in hertz or Hz) showing the simulated frequency responses of the surface acoustic wave SAW resonators with different interdigitated transducer (IDT) finger space designs.

FIG. 8A is a plot of vertical direction (in micrometres or μm) as a function of horizontal direction (in micrometres or μm) showing the simulated optical mode in a waveguide according to various embodiments.

FIG. 8B is a plot of impedance (in ohms) as a function of stress on the photonic waveguide (in mega Pascals or MPa) showing the simulated effect of stress on optical property of the waveguide according to various embodiments.

FIG. 8C is a plot of the optical output (measured in volts or V) as a function of the input angular rate (in degrees per second or deg/sec) illustrating the variation of the optical output of the gyroscope according to various embodiments due to the applied input angular rate.

FIG. 9A shows a simulated stress distribution of the gyroscope according to various embodiments as a result of a 100, 000 g acceleration along the x-axis.

FIG. 9B shows a simulated stress distribution of the gyroscope according to various embodiments as a result of a 100, 000 g acceleration along the y-axis.

FIG. 9C shows a simulated stress distribution of the gyroscope according to various embodiments as a result of a 100, 000 g acceleration along the z-axis.

FIG. 10A shows the scanning electron microscope (SEM) image of the fabricated opto-mechanical gyroscope according to various embodiments.

FIG. 10B shows the scanning electron microscope (SEM) image of the resonator of the fabricated gyroscope according to various embodiments.

FIG. 10C shows the scanning electron microscope (SEM) image of the reflector part of the resonator of the gyroscope according to various embodiments.

FIG. 10D is a schematic illustrating the designed surface acoustic wave (SAW) resonator according to various embodiments.

FIG. 10E shows the scanning electron microscope (SEM) image of a waveguide of the gyroscope according to various embodiments.

FIG. 10F shows the scanning electron microscope (SEM) image of a waveguide and the mass dot array of the gyroscope according to various embodiments.

FIG. 11A is a plot of magnitude (in decibels or dB) as a function of frequency (in gigahertz or GHz) showing the measured magnitude transmission response of the surface acoustic resonator of the gyroscope according to various embodiments.

FIG. 11B is a plot of phase (in degrees or deg) as a function of frequency (in gigahertz or GHz) showing the measured phase transmission response of the surface acoustic resonator of the gyroscope according to various embodiments.

FIG. 12A is a plot of power (in decibels (dB) with reference to one milliwatt (mW) or dBm) as a function of frequency (in megahertz of MHz) showing the measured spectrum of the surface acoustic wave (SAW) oscillator of the gyroscope according to various embodiments.

FIG. 12B is a plot of power (in decibels (dB) with reference to carrier or dBc) as a function of frequency (in megahertz of MHz) showing the measured phase noise of the surface acoustic wave (SAW) oscillator of the gyroscope according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

Embodiments described in the context of one of the methods or gyroscopes are analogously valid for the other methods or gyroscopes. Similarly, embodiments described in the context of a method are analogously valid for a gyroscope, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may also be used herein to mean that the deposited material may be formed “indirectly on” the implied side or surface with one or more additional layers being arranged between the implied side or surface and the deposited material. In other words, a first layer “over” a second layer may refer to the first layer directly on the second layer, or that the first layer and the second layer are separated by one or more intervening layers.

The gyroscope as described herein may be operable in various orientations, and thus it should be understood that the terms “top”, “topmost”, “bottom”, “bottommost” etc., when used in the following description are used for convenience and to aid understanding of relative positions or directions, and not intended to limit the orientation of the gyroscope.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

In order to reduce the bias drift of the MEMS gyroscope, the bias of the gyroscope should be reduced as much as possible. The two main sources causing the bias are: 1) electrical coupling between the driving signals and the sensing signals, and 2) electrical direct motion coupling. In order to achieve high bias stability, we should reduce these electrical couplings as much as possible.

Some groups proposed a surface acoustic wave (SAW) based gyroscope to achieve high stability to external vibrations and accelerations. Although the SAW based gyroscopes demonstrated the gyroscopic effect, the performances of these gyroscopes may still be far away from expectation. The driving and sensing interdigitated transducers (IDTs) still have large electrical coupling between each other.

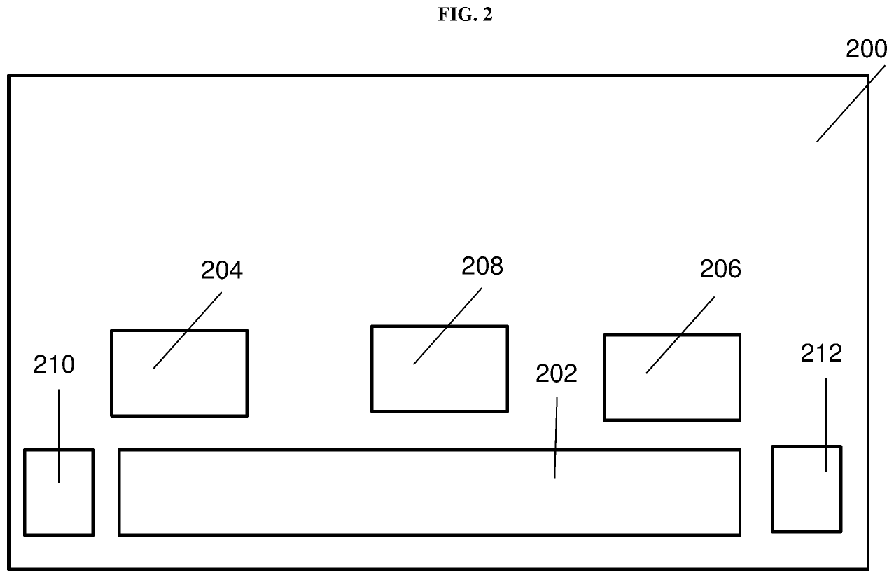

Various embodiments may provide a gyroscope. FIG. 2 shows a general illustration of the gyroscope 200 according to various embodiments. The gyroscope 200 may include a piezoelectric substrate 202. The gyroscope 200 may also include an excitation transducer 204 over or on the piezoelectric substrate 202, the excitation transducer 204 configured to generate a surface acoustic wave (SAW). The gyroscope 200 may further include a sensing transducer 206 over or on the piezoelectric substrate 202, the sensing transducer 206 configured to receive the surface acoustic wave generated by the excitation transducer 204. The gyroscope 200 may additionally include a mass dot array 208 over or on the piezoelectric substrate 202, and between the excitation transducer 204 and the sensing transducer 206, the mass dot array 208 configured to generate a stress on the piezoelectric substrate 202 based on a rotation of said gyroscope 200 upon the surface acoustic wave passing through the mass dot array 208. The gyroscope 200 may also include a light source 210. The gyroscope 200 may further include an optical detector 212 configured to receive one or more light beams generated by the light source 210 to determine the rotation of the gyroscope 200 based on a property of the one or more light beams. The property of the one or more light beams may be variable or changeable based on the stress on the piezoelectric substrate 202.

The gyroscope 200 may include a pair of transducers 204, 206 over a substrate 202. Surface acoustic waves traveling between the pair of transducers 204, 206 may pass through a mass dot array 208, and the vibrating mass dot array 208 may generate a stress distribution on the substrate 202 due to the Coriolis force acting on the mass dot array 208, the Coriolis force produced as a result of the rotation of the gyroscope 200. The rotation of the gyroscope 200 may be determined by analysing light passing from the light source 210 to the detector 212.

Various embodiments may address or mitigate the problems faced by conventional gyroscopes. Various embodiments may be robust as the gyroscope does not have suspended structures. Various embodiments may have high anti-shock ability, and may have high resistance to external vibrations and/or accelerations. Various embodiments may have little or no cross-coupling between the driving loop (electrical signals drive the transducers 208, 210), and the sense loop (optical signals passing from the light source 210 to the detector 212), thus resulting in high angular resolution. Various embodiments may have high bias stability.

In various embodiments, the mass dot array 208 may be configured to generate a secondary wave, the secondary wave orthogonal to the surface acoustic wave passing through the mass dot array 208, based on a Coriolis force acting on the mass dot array 208 due to the rotation of the gyroscope 200.

The secondary wave may be a further surface acoustic wave (SAW), and may be referred to as a rotation induced SAW. The surface acoustic wave generated by the excitation transducer 204 may be a standing wave.

The Coriolis force may be an inertial force that acts on an object that is in motion relative to a rotating reference frame.

The gyroscope 200 may be rotated about an axis. The axis along which the gyroscope 200 is rotated may be orthogonal to both the surface acoustic wave (generated by the excitation transducer 204) and the secondary wave (generated by the mass dot array 208).

The mass dot array 208 may include a plurality of microstructures or nanostructures. For instance, the mass dot array 208 may include a plurality of microparticles or nanoparticles. The mass dot array 208 may be a regular, periodic array. The mass dot array 208 may be on or over the substrate 202. The mass dot array 208 may also be between the excitation transducer 204 and the sensing transducer 206.

The size of each mass dot (or each microstructure or nanostructure) may be dependent on the wavelength of the excited surface acoustic wave (SAW). Generally, the size of each mass dot (or each microstructure or nanostructure) may be a square of a length substantially equal to ¼ of a wavelength of the SAW.

The piezoelectric substrate 202 may include a suitable piezoelectric material e.g. lithium niobate (LiNiO₃), lithium tantalate (LiTaO₃), aluminum nitride (AlN), zinc oxide (ZnO), or gallium nitride (GaN).

The piezoelectric substrate 202 may be a piezoelectric film.

In various embodiments, the light source 210 and/or the detector 212 may be on chip. The light source 210 and/or the detector 212 may be over or on the piezoelectric substrate 202.

In various other embodiments, the light source 210 and/or the detector 212 may be off chip.

In various embodiments, the light source 210 may be a laser source. Correspondingly, the one or more light beams may be laser beam(s).

The excitation transducer 202 may be an interdigitated transducer (IDT). The excitation transducer 202 may be referred to as a first interdigitated electrode

The sensing transducer 204 may be an interdigitated transducer (IDT). The sensing transducer 204 may be referred to as a second interdigitated electrode.

The gyroscope 200 may include a sustaining circuit in electrical connection with the excitation transducer 202 and the sensing transducer 204. The sustaining circuit may be configured to receive a transducer output signal from the sensing transducer 204 and may be further configured to provide a feedback signal to the excitation transducer 202 based on the transducer output signal so that a standing wave of constant amplitude oscillating at a resonant frequency is generated passing through the mass dot array 208 between the excitation transducer 202 and the sensing transducer 204. The sustaining circuit may be or may include a sustaining amplifier. The sustaining circuit may be configured to generate an amplified transducer output signal based on the transducer output signal. The sustaining circuit may also be referred to as a sustain circuit.

The gyroscope 200 may further include a demodulator configured to receive the transducer output signal from the sensing transducer 204, or an amplified transducer output signal from the sustaining circuit.

In various embodiments, the gyroscope 200 may include an amplifier coupled to the optical detector 212 and the demodulator. The amplifier may receive the optical output signal generated by the optical detector 212, and may amplify the optical output signal optical output signal generated by the optical detector 212 before transmitting to the demodulator. The amplifier may receive the optical output signal generated by the optical detector 212, and may generate the amplified optical output signal based on the optical output signal.

The demodulator may be further configured to receive an optical output signal generated by the optical detector 212 based the one or more light beams, or an amplified optical output signal generated by an amplifier coupled to the optical detector 212 and the demodulator.

The optical output signal (or amplified output signal) may be based on an oscillating frequency of the surface acoustic wave.

The demodulator may be configured to generate a demodulated output signal based on a demodulation of the optical output signal (or amplified output signal) by the transducer output signal (or amplified transducer output signal). The rotation of the gyroscope 200 may be determined based on the demodulated output signal.

In various embodiments, the gyroscope 200 may include a first waveguide positioned lateral to a first side of the mass dot array 208. The gyroscope 200 may also include a second waveguide positioned lateral to a second side of the mass dot array opposite the first side (of the mass dot array 208). In other words, the mass dot array 208 may be between the first waveguide and the second waveguide. The first waveguide and the second waveguide may be over or on the piezoelectric substrate 202.

The gyroscope 200 may also include a first Y-coupler configured to optically couple the light source to a first end of the first waveguide and a first end of the second waveguide. The gyroscope 200 may also include a second Y-coupler configured to optically couple the optical detector to a second end of the first waveguide and a second end of the second waveguide. The first Y-coupler and/or the second Y-coupler may be over or on the piezoelectric substrate 202.

A Y-coupler may be an optical coupler that has three branches or waveguides (joined or coupled together in a Y-shape). A light beam directed into a first branch may be split and may pass out as separate output light beams from the second branch and the third branch. Further, a first light beam directed into the first branch and a second light beam directed into the second branch may be combined and pass out of the third branch as a single output light beam.

The one or more light beams may travel from the light source 210 to the first Y-coupler, where the one or more light beams may be split up. A first light beam of the one or more light beams may be directed by the first Y-coupler to the first waveguide, and a second light beam of the one or more light beams may be directed by the first Y-coupler to the second waveguide. In such a scenario, the one or more light beams may refer to a plurality of light beams.

The stress generated by the mass dot array 208 on the piezoelectric substrate 202 may cause a tensile stress on the first waveguide and a compressive stress on the second waveguide. The first waveguide may under a change in an effective refractive index due to the tensile stress. The second waveguide may undergo a change in an effective refractive index (that is opposite to the change (in the effective refractive index) that is undergone by the first waveguide) due to the compressive stress.

A first light beam of the one or more light beams traveling through the first waveguide may undergo a phase delay due to the tensile stress. A second light beam of the one or more light beams traveling through the second waveguide may undergo a phase forward due to the compressive stress.

The second Y-coupler may be coupled to the first waveguide and the second waveguide in such a manner that the second Y-coupler is configured to recombine the one or more light beams, which may travel to the optical detector 212. For instance, the first light beam and the second light beam and recombine to form an interference light beam. The light beam that give rise to the first light beam and the second light beam, i.e. the light beam generated by the light source 210 before splitting at the first Y-coupler, may be referred to as the original light beam.

The rotation of the gyroscope 202 may be determined based on a phase difference between the first light beam and the second light beam, i.e. upon the light detector 212 receiving the interference light beam. The phase difference between the first light beam and the second light beam may be determined by determining an intensity of an interference light beam generated by an interference of the first light beam and the second light beam. The intensity of the interference light beam received by the detector may be different from the intensity of the original light beam. Accordingly, an intensity of the one or more light beams received by the light detector 212 may be different from an intensity of the one or more light beams generated by the light source 210. An output voltage may be determined from the gyroscope. The output voltage may be dependent on the property of the one or more light beams, e.g. the change in intensity of the one or more light beams.

In various other embodiments, the gyroscope 200 may include a ring resonator that is optically coupled between the light source and the optical detector. An input of the ring resonator may be optically coupled to the light source and an output of the ring resonator may be optically coupled to the optical detector. The ring resonator may be over or on the substrate 202. The gyroscope 200 may have an input waveguide or an input waveguide section coupling the light source 210 to the ring resonator. The gyroscope 200 may have an output waveguide or an output waveguide section coupling the ring resonator to the optical detector 212.

The stress on the piezoelectric substrate 202 may cause a change in effective refractive index of the ring resonator, thus changing an intensity of the one or more light beams passing from the light source to the optical detector through the ring resonator.

In various embodiments, the property of the one or more light beams that is variable may refer to an intensity of the one or more light beams.

The gyroscope 200 may be an integrated opto-mechanics gyroscope (IOMG).

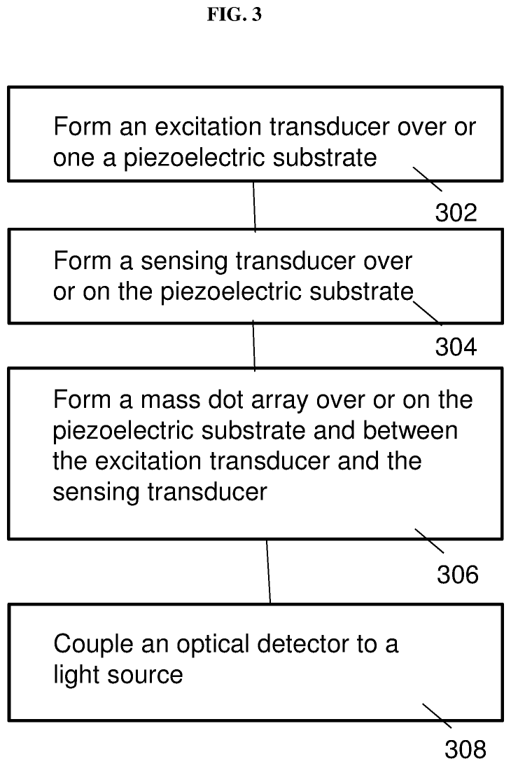

Various embodiments may provide a method of forming a gyroscope. FIG. 3 shows a general illustration of a method of forming the gyroscope according to various embodiments. The method may include, in 302, forming an excitation transducer over or on a piezoelectric substrate, the excitation transducer configured to generate a surface acoustic wave. The method may also include, in 304, forming a sensing transducer over or on the piezoelectric substrate, the sensing transducer configured to receive the surface acoustic wave generated by the excitation transducer. The method may additionally include, in 306, forming a mass dot array over or on the piezoelectric substrate and between the excitation transducer and the sensing transducer, the mass dot array configured to generate a stress on the piezoelectric substrate based on a rotation of said gyroscope upon the surface acoustic wave passing through the mass dot array. The method may also include, in 308, coupling an optical detector to a light source. The optical detector may be configured to receive one or more light beams generated by the light source to determine the rotation of the gyroscope based on a property of the one or more light beams. The property of the one or more light beams may be variable or changeable based on the stress on the piezoelectric substrate.

The method of forming the gyroscope may include forming the excitation transducer, the sensing transducer, as well as the mass dot array over or on the piezoelectric substrate. The method may further include optically coupling a light source to an optical detector such that the one or more light beams generated by the light source and received by the optical detector may be used to determine the rotation of the gyroscope based on a property of the one or more light beams.

For avoidance of doubt, the steps shown in FIG. 3 is not intended to be in sequence. For instance step 302 may occur before step 304, or may occur after or concurrently with step 304.

The method may further include electrically connecting a sustaining circuit with the excitation transducer and the sensing transducer. The sustaining circuit may be configured to receive a transducer output signal from the sensing transducer and may be further configured to provide a feedback signal to the excitation transducer based on the transducer output signal so that a standing wave of constant amplitude oscillating at a resonant frequency is generated passing through the mass dot array between the excitation transducer and the sensing transducer.

The method may also include coupling a demodulator to the sensing transducer via the sustaining circuit, and the optical detector via an amplifier. The demodulator may be configured to receive the transducer output signal from the sensing transducer, or an amplified transducer output signal from the sustaining circuit.

The method may include coupling an amplifier to the optical detector. The demodulator may be further configured to receive an optical output signal generated by the optical detector based the one or more light beams, or an amplified optical output signal generated by the amplifier. The demodulator may be configured to generate a demodulated output signal based on a demodulation of the optical output signal (or the amplified optical output signal) by the transducer output signal (or the amplified transducer output signal). The rotation of the gyroscope may be determined based on the demodulated output signal.

In various embodiments, the method may include forming or positioning a first waveguide lateral to a first side of the mass dot array. The method may also include forming or positioning a second waveguide positioned lateral to a second side of the mass dot array opposite the first side. The method may additionally include forming or positioning a first Y-coupler configured to optically couple the light source to a first end of the first waveguide and a first end of the second waveguide. The method may also include forming or positioning a second Y-coupler configured to optically couple the optical detector to a second end of the first waveguide and a second end of the second waveguide. The first waveguide, the second waveguide, the first Y-coupler, and/or the second Y-coupler may be formed or positioned on or over the piezoelectric substrate.

In various other embodiments, the method may include forming or positioning a ring resonator that is optically coupled between the light source and the optical detector.

The method may include providing the piezoelectric substrate. The method may also include providing the light source. The method may also include providing the optical detector. The light source and/or the optical detector may be on-chip or off-chip.

In various embodiments, determining the rotation of the gyroscope may refer to determining the applied input angular rate on the gyroscope.

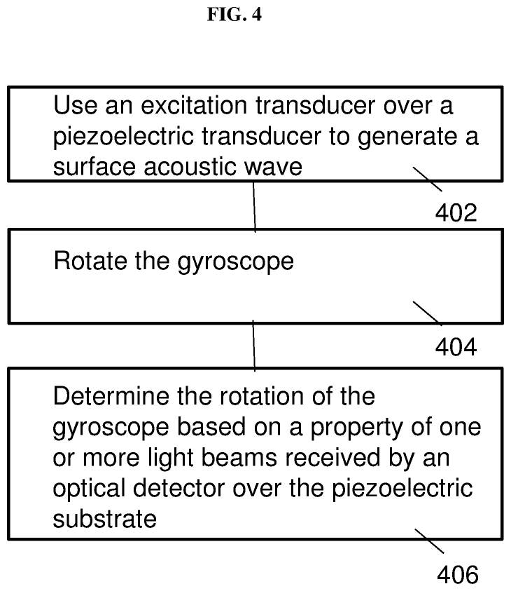

Various embodiments may provide a method of operating a gyroscope. FIG. 4 shows a general illustration of a method of operating the gyroscope according to various embodiments. The method may include, in 402, using an excitation transducer, the excitation transducer over a piezoelectric transducer, to generate a surface acoustic wave so that the surface acoustic wave is received by a sensing transducer over the piezoelectric substrate. The surface acoustic wave may pass through a mass dot array, the mass dot array between the excitation transducer and the sensing transducer and over the piezoelectric substrate. The method may further include, in 404, rotating the gyroscope so that the array generates a stress on the piezoelectric substrate based on said rotation of the gyroscope upon the surface acoustic wave passing through the mass dot array. The method may also include, in 406, determining the rotation of the gyroscope based on a property of one or more light beams received by an optical detector over the piezoelectric substrate, the optical detector optically coupled to a light source over the piezoelectric substrate. The property of the one or more light beams may be variable or changeable based on the stress on the piezoelectric substrate.

The method of operating the gyroscope may include exciting the transducer to generate the surface acoustic waves and rotating the gyroscope. The rotation of the gyroscope may then be determined based on a property one or more light beams travelling from the light source to the optical detector as the property may be variable or changeable due to stress on the piezoelectric substrate caused by the rotation of the gyroscope.

For avoidance of doubt, the steps shown in FIG. 4 is not intended to be in sequence.

In various embodiments, using an excitation transducer may include applying a voltage to the excitation transducer. A potential difference may be applied between the excitation transducer and the sensing transducer.

In various embodiments, the method may further include activating or turning on the light source.

In various embodiments, determining the rotation of the gyroscope may include determining an output voltage of the gyroscope, the output voltage dependent on the property of the one or more light beams, e.g. the change in intensity of the one or more light beams

The mass dot array may be configured to generate a secondary wave, the secondary wave orthogonal to the surface acoustic wave passing through the mass dot array, based on a Coriolis force acting on the mass dot array due to the rotation of the gyroscope.

An axis along which the gyroscope is rotated may be orthogonal to both the surface acoustic wave and the secondary wave.

The property of the one or more light beams may be an intensity of the one or more light beams, or a change in intensity of the one or more light beams.

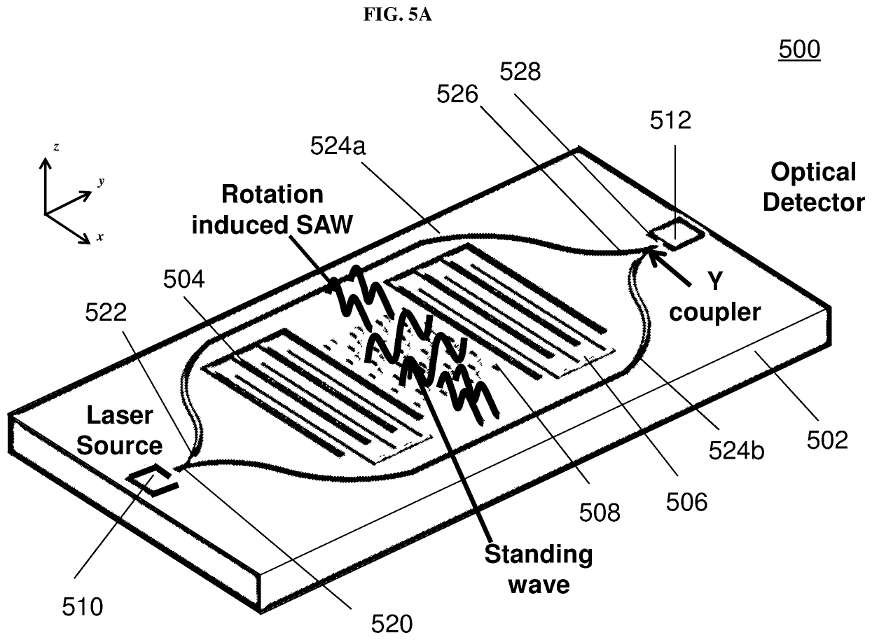

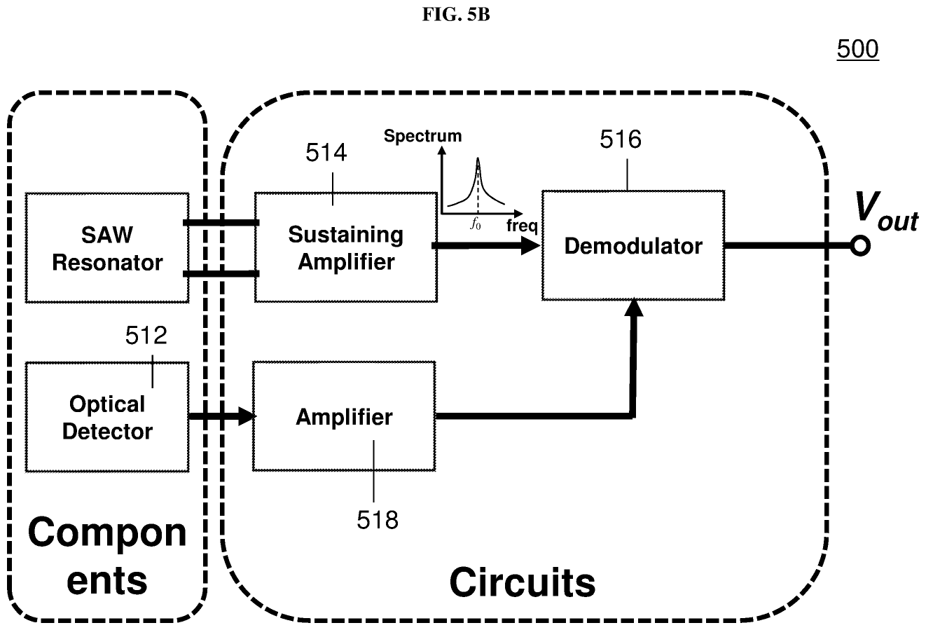

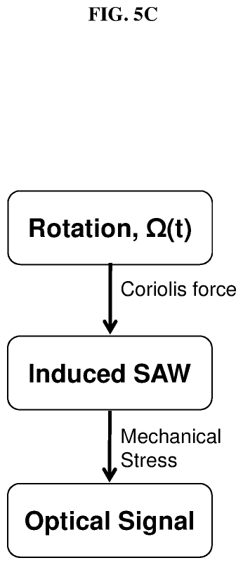

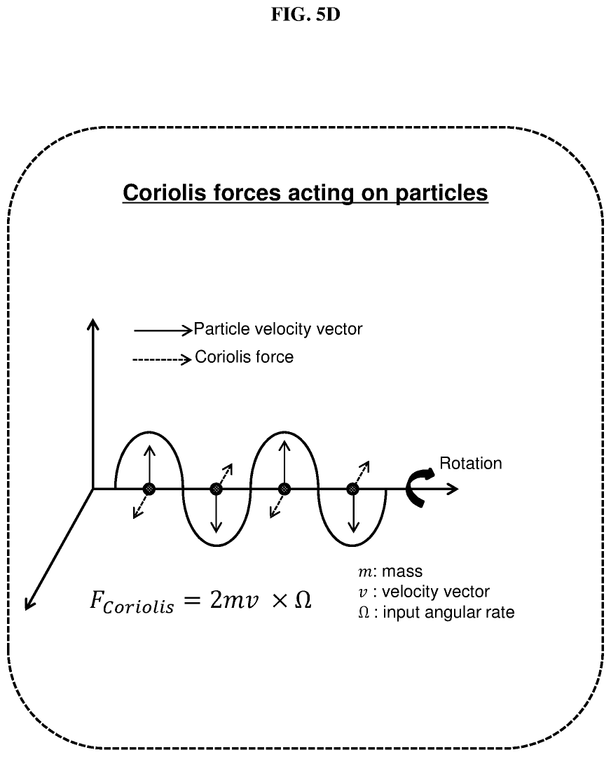

FIG. 5A shows a schematic of a gyroscope 500 according to various embodiments. The gyroscope 500 may be an integrated opto-mechanics gyroscope (IOMG). The gyroscope may include a SAW based mechanical excitation part, and a stress sensitive waveguide based optical sensing part. The gyroscope 500 may be based on a surface acoustic wave (SAW) resonator, and a stress sensitive waveguide. The various components may be made or formed on a piezoelectric substrate 502.

The SAW resonator may include an excitation inter-digital transducer (IDT) 504, the sensing IDT 506, and a resonant cavity between the excitation IDT 502 and the sensing IDT 504. The excitation IDT 504 may excite a standing wave in the resonant cavity including a mass dot array 508.

FIG. 5B shows a diagram block of the gyroscope 500 according to various embodiments. The component portion of the gyroscope 500 is already illustrated in FIG. 5A, and may include the SAW resonator (which includes IDTs 504, 506 and the resonant cavity), and the optical detector 512.

The sensing IDT 506 may be used to detect the output signals of the SAW resonator and feedback to a sustaining circuit 514 to make the SAW resonator oscillate at a resonant frequency. The sustaining circuit 514 may maintain the SAW resonator oscillating with a constant amplitude.

The gyroscope 500 may further include a demodulator 516 coupled to the sustaining circuit 514, which may be a sustaining amplifier. The gyroscope 500 may further include an amplifier 518 coupled to the optical detector 512. An output signal of the optical detector 512 may be amplified by the amplifier 518 before being transmitted to the demodulator 516. The demodulator 516 may be coupled to the amplifier 518.

The amplified output signal may be demodulated by the oscillation frequency of the SAW resonator. The induced rotation rate may be deduced by the amplitude of the output voltage signal Vₒᵤₜ from the demodulator 516.

When the gyroscope 500 is rotated about the z-axis (see FIG. 5A), the Coriolis force acting on the vibrating mass dot array 508 may induce a secondary wave in the orthogonal direction of the standing wave. The standing wave may be parallel to the y-axis, while the second wave may be parallel to the x-axis.

The induced secondary wave may cause periodic stress distribution on the surface of the piezoelectric substrate 502. The stress distribution may be detected using stress-sensitive optical sensing technology. FIG. 5C is a schematic illustrate the different signals generated by the gyroscope 500 according to various embodiments. FIG. 5D is a schematic illustrating the Coriolis force generated by a particle according to various embodiments.

FIG. 5A illustrates a differential optical sensing design. The laser source 510 may generate a light. The light may be coupled to an input waveguide 520, and may be split into two light beams by a Y-coupler 522 coupled to the input waveguide 520. Each of the two light beams may pass through a respective waveguide 524a, 524b. The SAW resonator may be between the two waveguides 524a, 524b. The two waveguides 524a, 524b may be parallel to each other may be referred to as sensing waveguides.

Then, the two light beams may be coupled or combined together by another Y-coupler 526, and may undergo interference along output waveguide 528 before they enter into an optical detector 512. One waveguide 524a (left side of the SAW resonator) may undergoes the tensile stress, and the other waveguide 524b on the other side (right side of the SAW resonator) may undergo compression stress. The tensile stress may cause phase delay to the light beam traveling along waveguide 524a, and the compression stress may cause phase forward to the light beam traveling along waveguide 524b. The phase difference of the two light beams may be deduced by measuring the intensity of the interference light based on the two light beams. The output intensity (or change of output intensity from input intensity) of the light may indicate a phase difference of the two beams, which is caused by the Coriolis force induced stresses. Thus, the rotation that is applied may be deduced. The differential approach may reduce or eliminate common error signals caused by the external temperature changes or mechanical inferences.

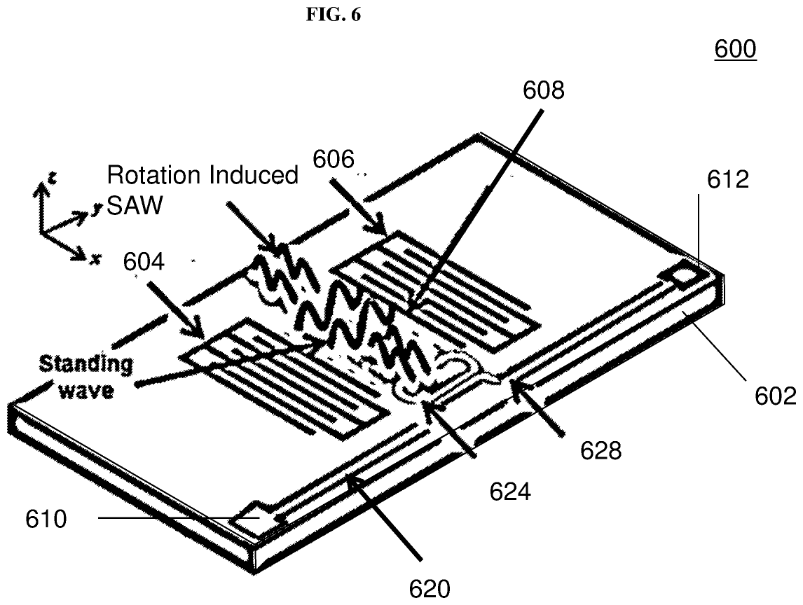

FIG. 6 shows a schematic of a gyroscope 600 according to various other embodiments. The gyroscope 600 may be a single-end stress sensing design. The gyroscope 600 may include a piezoelectric substrate 602, as well as an excitation interdigitated transducer (IDT) 604 and a sensing interdigitated transducer (IDT) 606 on the piezoelectric substrate 602. The gyroscope may further include a mass dot array 608 on the piezoelectric substrate 602, the mass dot array 608 between the excitation interdigitated transducer (IDT) 604 and the sensing interdigitated transducer (IDT) 606.

The gyroscope 600 may further include a laser source 610, an optical detector 612, a bus waveguide 620, 628 (or referred to as a stress sensitive waveguide), and a ring resonator 624. The optical detector 612, bus waveguide 620, 628, and ring resonator 624 may form the optical readout configuration. The bus waveguide 620, 628 may include an input section 620 configured to carry light from the laser source 610 to the ring resonator 624, and an output section 628 configured to carry light from the ring resonator 624 to the optical detector 612. In other words, the bus waveguide 620, 628 may be used to couple the light into and out from the ring resonator 624.

The mechanical stress induced by the Coriolis force may load onto the ring resonator 624, which may then generate a small variation of the effective refractive index. The small variation of the effective refractive index may affect the output light intensity of the ring resonator 624.

In various embodiments, the laser source 510, 610, and the detector 512, 612 may be integrated on chip. In various other embodiments, the laser source 510, 610, and the detector 512, 612 may be off chip. In other words, an off chip laser source and off chip detector may be used. The off chip laser source and the off chip detector may be integrated with the remaining components on board level.

One feature of the gyroscope according to various embodiments is that the gyroscope has no suspended structure. Therefore, the gyroscope may be highly robust, and may have excellent resilience to external accelerations and vibrations.

Another advantage of the gyroscope according to various embodiments is that there may be no cross coupling between the drive loop and the sense loop. The drive loop may be based on the electrical signals, and the sensing loop may be based on the optical signals. There may be no cross-coupling between the drive loop and the sense loop, which results in a high angular resolution.

The gyroscope may include a piezoelectric substrate or a piezoelectric film (which can support a SAW along its surface), a SAW resonator, a mass dot array, and an optical readout configuration (including stress-sensitive waveguide(s)).

Finite elements method (FEM) simulation is done using COMSOL may help in the design of the SAW resonator.

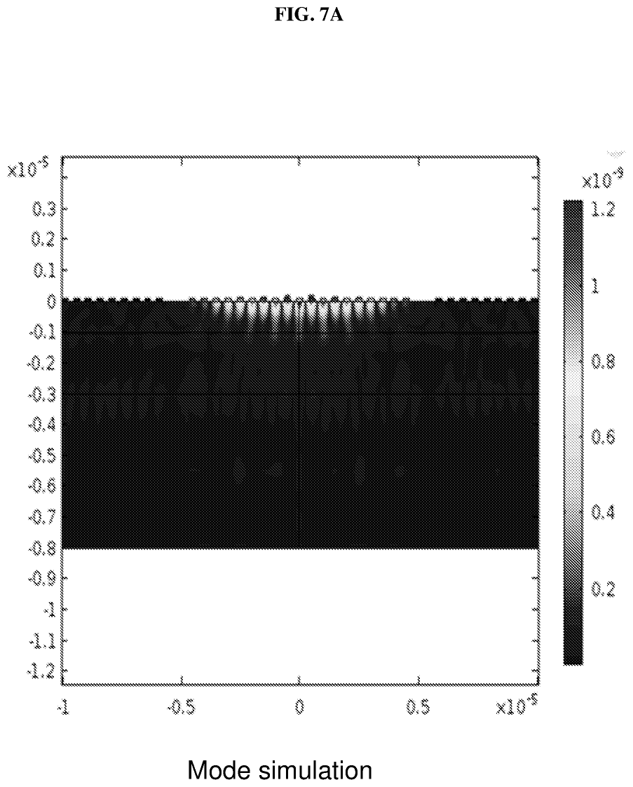

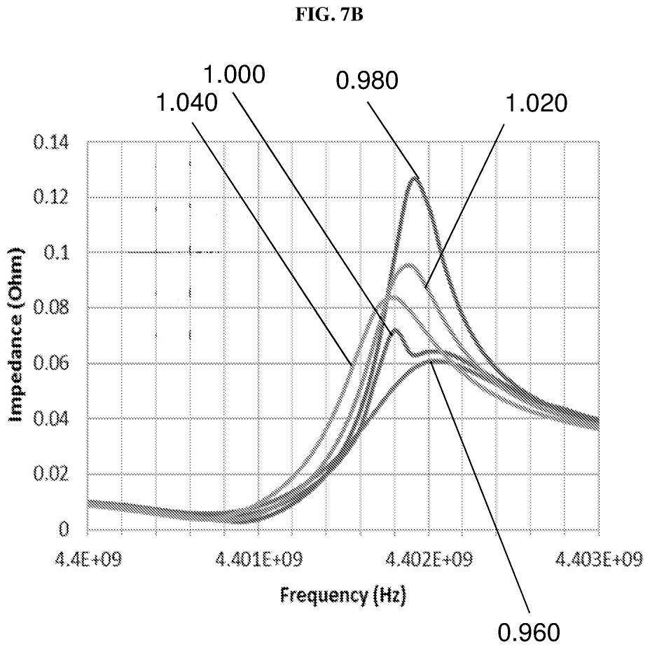

FIG. 7A is a plot of depth (in ×10⁻⁵ metres or m) as a function of (in ×10⁻⁵ in metres or m) showing the simulated standing mode shape of the gyroscope according to various embodiments. FIG. 7A shows the surface acoustic wave mode shape.

FIG. 7B is a plot of impedance (in ohms) as a function of frequency (in hertz or Hz) showing the simulated frequency responses of the surface acoustic wave SAW resonators with different interdigitated transducer (IDT) finger space designs. The different curves in FIG. 7B represents IDTs with different spacings between the fingers and the reflectors. The numbers denoting the different lines are in micrometres.

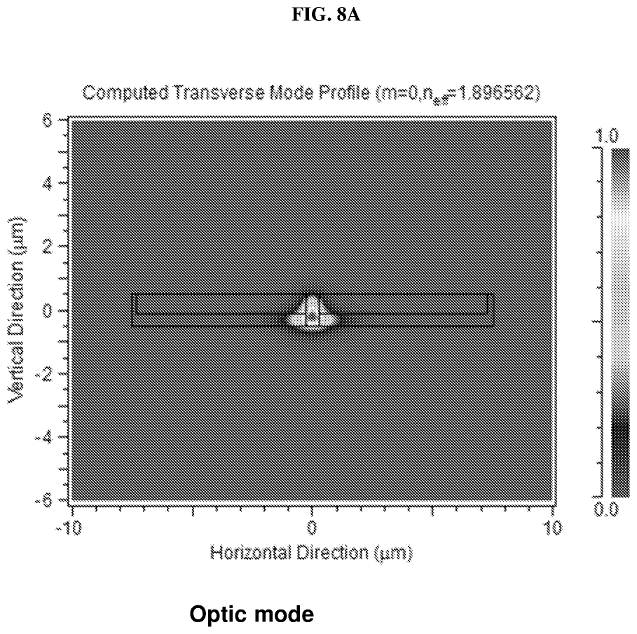

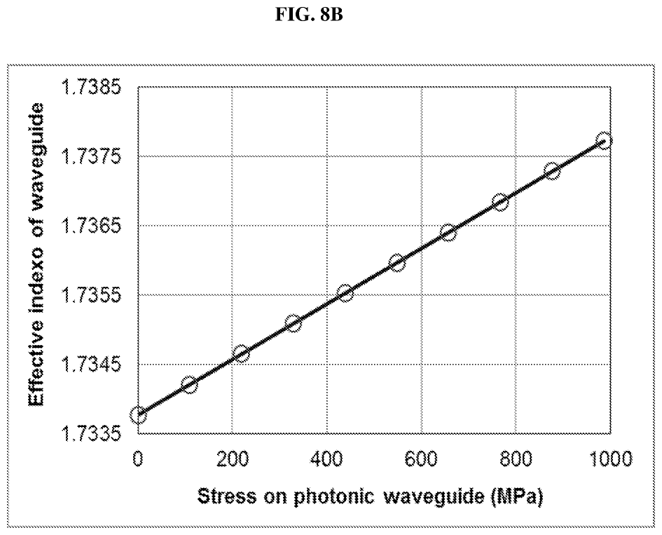

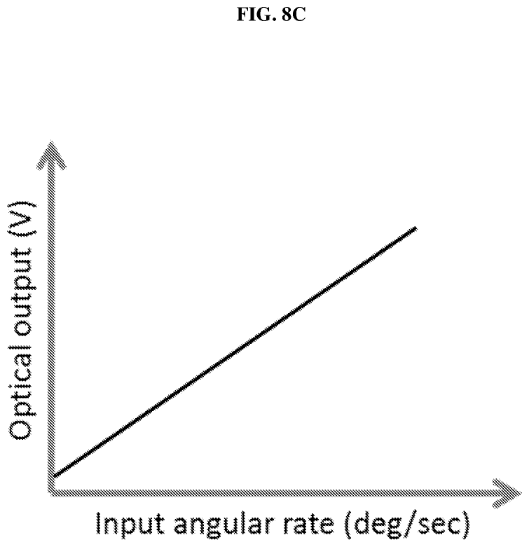

FIG. 8A is a plot of vertical direction (in micrometres or μm) as a function of horizontal direction (in micrometres or μm) showing the simulated optical mode in a waveguide according to various embodiments. FIG. 8B is a plot of impedance (in ohms) as a function of stress on the photonic waveguide (in mega Pascals or MPa) showing the simulated effect of stress on optical property of the waveguide according to various embodiments. FIG. 8B illustrates the dependence of the effective refractive index (η_{eff}) of the waveguide due to the applied stress. The variation of the effective refractive index (η_{eff}) of the waveguide due to the applied stress may be used to deduce the applied input angular rate on the gyroscope. FIG. 8C is a plot of the optical output (measured in volts or V) as a function of the input angular rate (in degrees per second or deg/sec) illustrating the variation of the optical output of the gyroscope according to various embodiments due to the applied input angular rate.

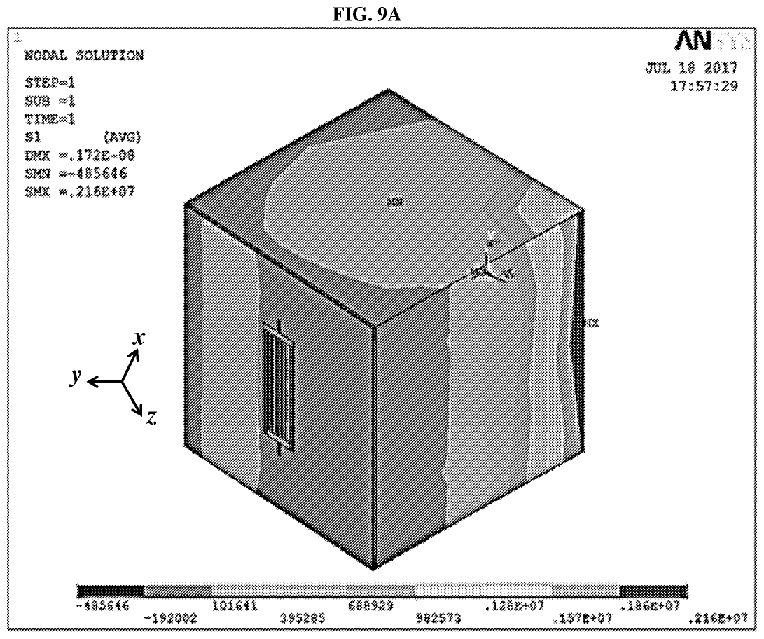

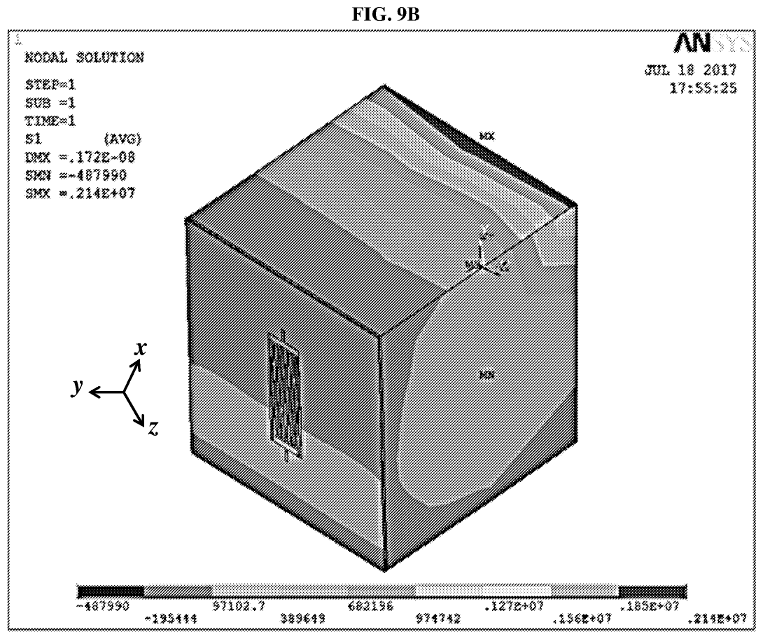

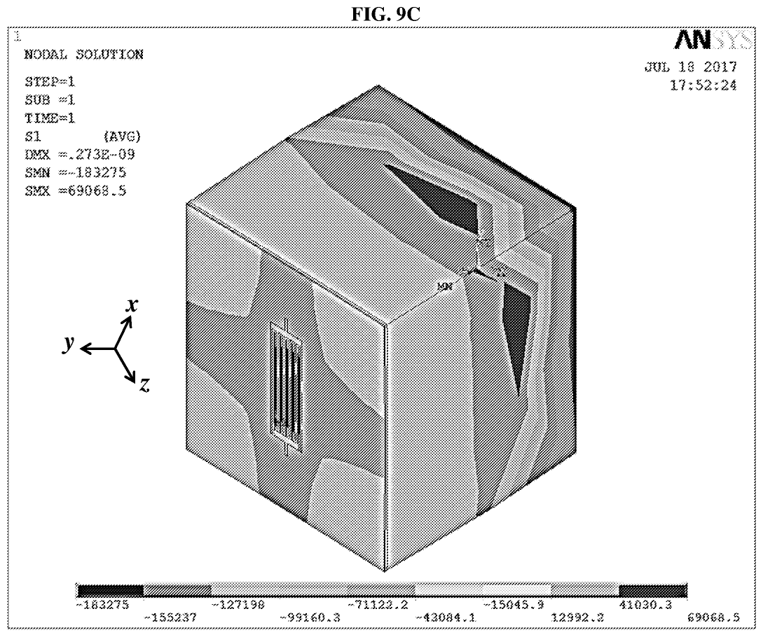

The opto-mechanical gyroscope may have a high anti-shock ability and may be immune to external vibrations. FIG. 9A shows a simulated stress distribution of the gyroscope according to various embodiments as a result of a 100, 000 g acceleration along the x-axis. FIG. 9B shows a simulated stress distribution of the gyroscope according to various embodiments as a result of a 100, 000 g acceleration along the y-axis. FIG. 9C shows a simulated stress distribution of the gyroscope according to various embodiments as a result of a 100, 000 g acceleration along the z-axis. The simulation results indicate that the gyroscope may endure 100, 000 g accelerations along the x-axis, y-axis, and z-axis.

The gyroscope may be fabricated based on aluminum nitride (AlN) on a silicon wafer. The MN may be a piezoelectric film. Surface acoustic waves may be excited in the AlN piezoelectric film.

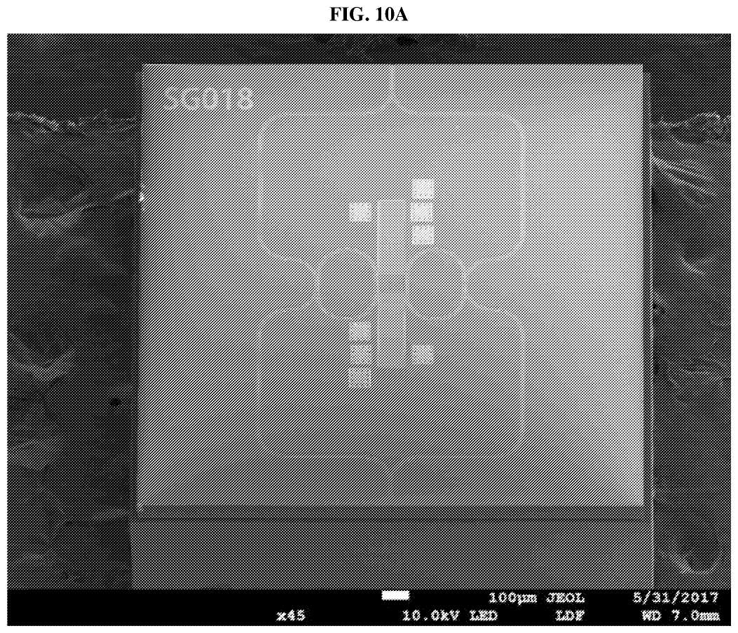

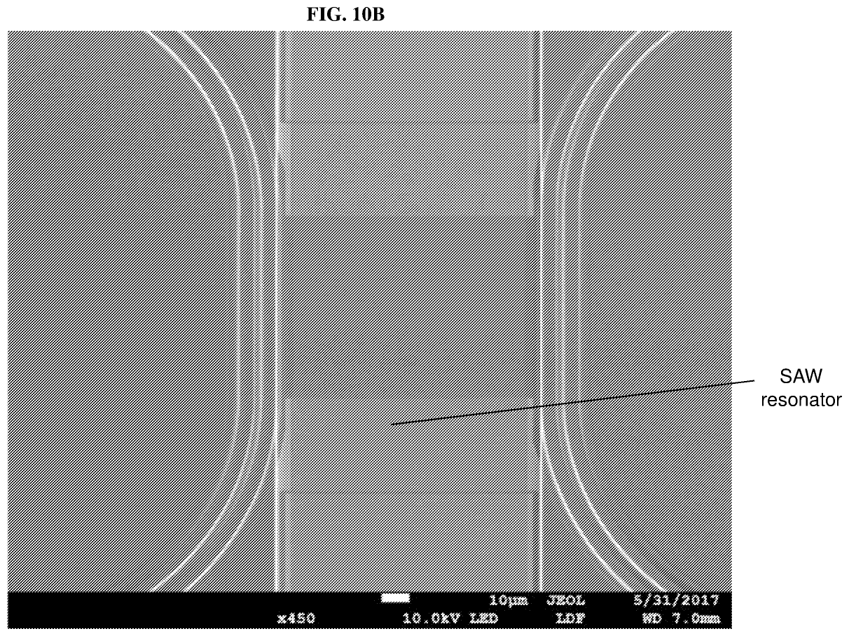

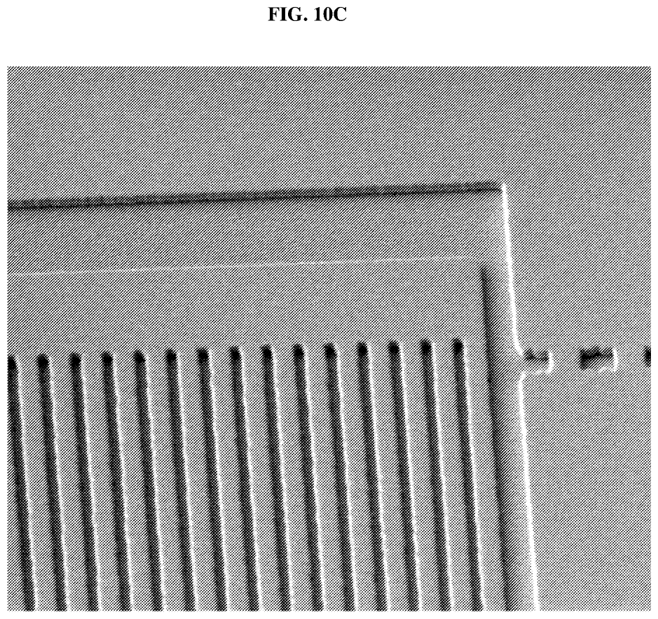

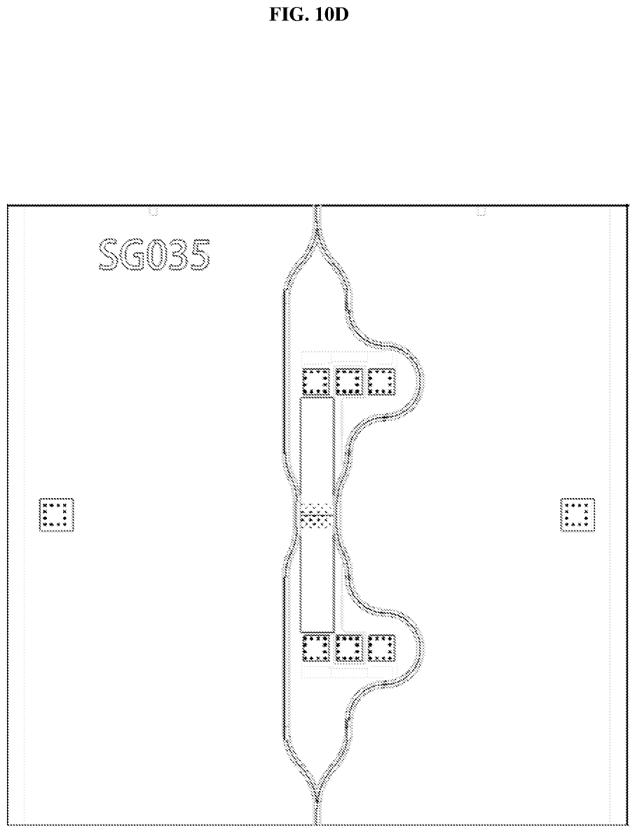

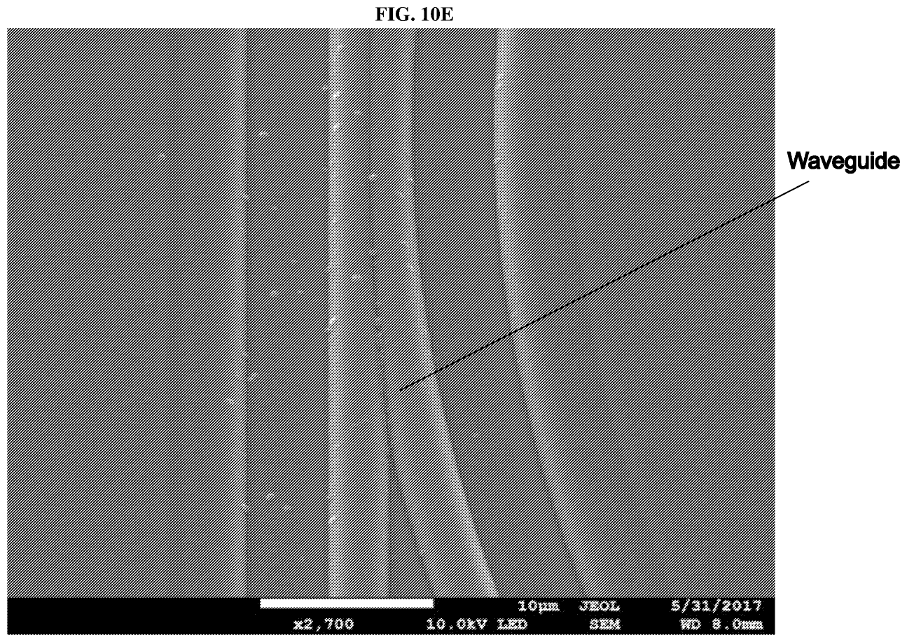

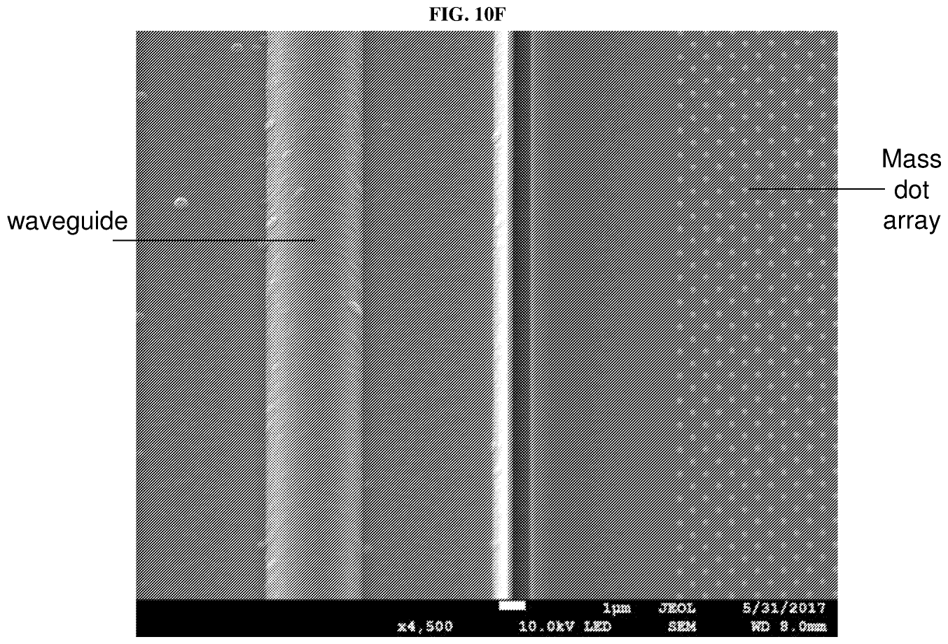

FIG. 10A shows the scanning electron microscope (SEM) image of the fabricated opto-mechanical gyroscope according to various embodiments. FIG. 10B shows the scanning electron microscope (SEM) image of the resonator of the fabricated gyroscope according to various embodiments. FIG. 10C shows the scanning electron microscope (SEM) image of the reflector part of the resonator of the gyroscope according to various embodiments. FIG. 10D is a schematic illustrating the designed surface acoustic wave (SAW) resonator according to various embodiments. FIG. 10E shows the scanning electron microscope (SEM) image of a waveguide of the gyroscope according to various embodiments. FIG. 10F shows the scanning electron microscope (SEM) image of a waveguide and the mass dot array of the gyroscope according to various embodiments.

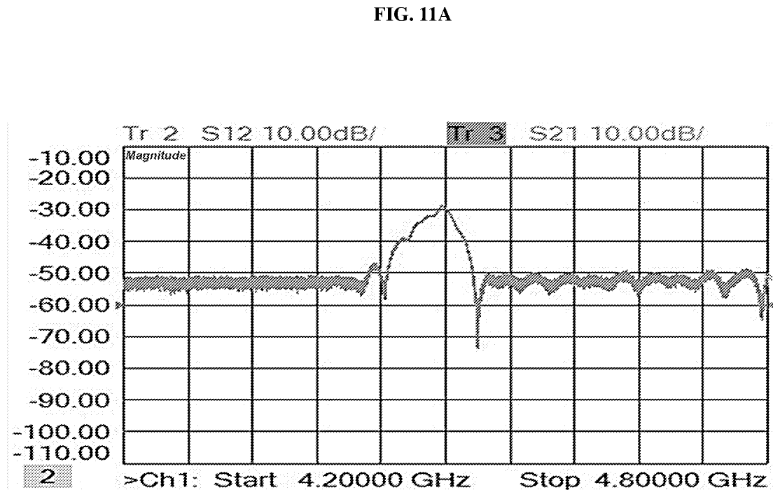

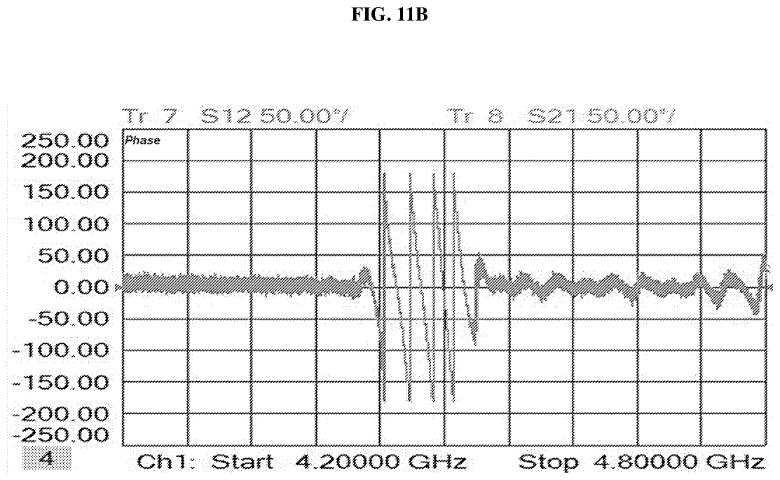

The transmission response of the SAW resonator is characterized using a network analyzer. FIG. 11A is a plot of magnitude (in decibels or dB) as a function of frequency (in gigahertz or GHz) showing the measured magnitude transmission response of the surface acoustic resonator of the gyroscope according to various embodiments. FIG. 11B is a plot of phase (in degrees or deg) as a function of frequency (in gigahertz or GHz) showing the measured phase transmission response of the surface acoustic resonator of the gyroscope according to various embodiments.

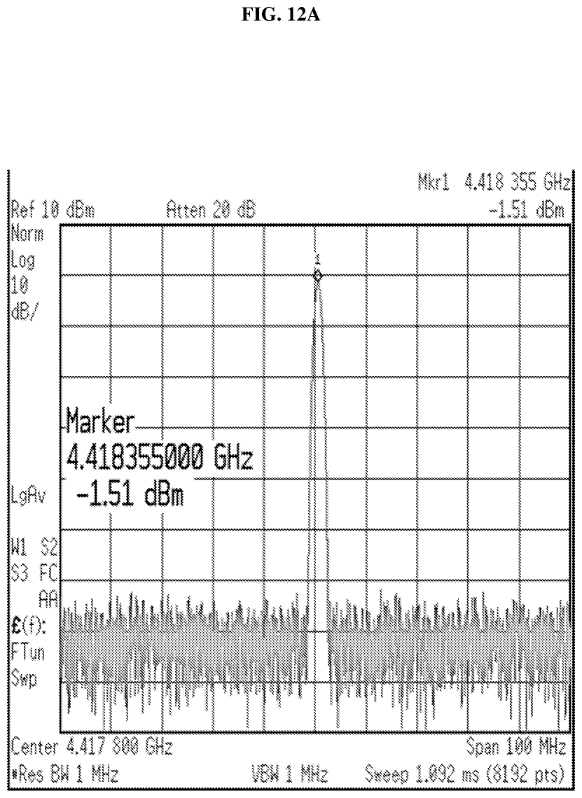

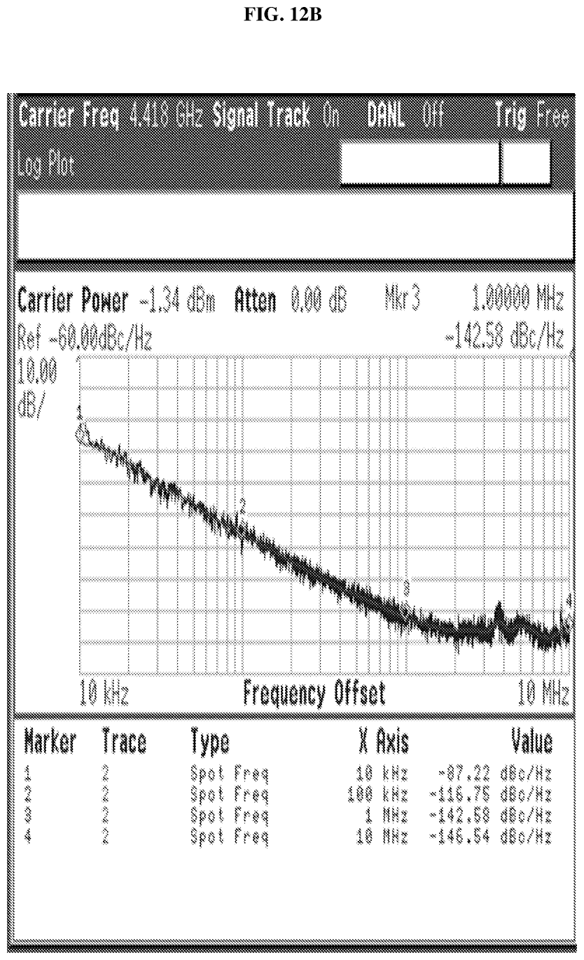

The SAW resonator may be connected to a sustain amplifier to achieve the oscillation. FIG. 12A is a plot of power (in decibels (dB) with reference to one milliwatt (mW) or dBm) as a function of frequency (in megahertz of MHz) showing the measured spectrum of the surface acoustic wave (SAW) oscillator of the gyroscope according to various embodiments. FIG. 12B is a plot of power (in decibels (dB) with reference to carrier or dBc) as a function of frequency (in megahertz of MHz) showing the measured phase noise of the surface acoustic wave (SAW) oscillator of the gyroscope according to various embodiments. FIG. 12B shows the measured phase noise of the SAW oscillator output at 4.4 GHz. The oscillation power is −1.34 dBm. The measured phase noises are −87.22 dBc/Hz, −116.75 dBc/Hz, −142.58 and −146.54 dBc/Hz with offsets of 10 kHz, 100 kHz, 1 MHz and 10 MHz, respectively.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A gyroscope comprising:
a piezoelectric substrate;
an excitation transducer over the piezoelectric substrate, the excitation transducer configured to generate a surface acoustic wave;
a sensing transducer over the piezoelectric substrate, the sensing transducer configured to receive the surface acoustic wave generated by the excitation transducer;
a mass dot array over the piezoelectric substrate and between the excitation transducer and the sensing transducer, the mass dot array configured to generate a stress on the piezoelectric substrate based on a rotation of said gyroscope upon the surface acoustic wave passing through the mass dot array;
a light source; and
an optical detector optically coupled to the light source;
wherein the optical detector is configured to receive one or more light beams generated by the light source to determine the rotation of the gyroscope based on a property of the one or more light beams; and
wherein the property of the one or more light beams is variable based on the stress on the piezoelectric substrate.

2. The gyroscope according to claim 1,
wherein the mass dot array is configured to generate a secondary wave, the secondary wave orthogonal to the surface acoustic wave passing through the mass dot array, based on a Coriolis force acting on the mass dot array due to the rotation of the gyroscope.

3. The gyroscope according to claim 2,
wherein an axis along which the gyroscope is rotated is orthogonal to both the surface acoustic wave and the secondary wave.

4. The gyroscope according to claim 1,
wherein the mass dot array comprises a plurality of microstructures or nano structures.

5. The gyroscope according to claim 1, further comprising:
a sustaining circuit in electrical connection with the excitation transducer and the sensing transducer;
wherein the sustaining circuit is configured to receive a transducer output signal from the sensing transducer and further configured to provide a feedback signal to the excitation transducer based on the transducer output signal so that a standing wave of constant amplitude oscillating at a resonant frequency is generated passing through the mass dot array between the excitation transducer and the sensing transducer.

6. The gyroscope according to claim 5, further comprising:
a demodulator configured to receive the transducer output signal from the sensing transducer,
wherein the demodulator is further configured to receive an optical output signal generated by the optical detector based the one or more light beams; and
wherein the demodulator is configured to generate a demodulated output signal based on a demodulation of the optical output signal by the transducer output signal;
wherein the rotation of the gyroscope is determined based on the demodulated output signal.

7. The gyroscope according to claim 1, further comprising:
a first waveguide positioned lateral to a first side of the mass dot array;
a second waveguide positioned lateral to a second side of the mass dot array opposite the first side;
a first Y-coupler configured to optically couple the light source to a first end of the first waveguide and a first end of the second waveguide;
a second Y-coupler configured to optically couple the optical detector to a second end of the first waveguide and a second end of the second waveguide.

8. The gyroscope according to claim 7,
wherein the stress generated by the mass dot array on the piezoelectric substrate causes a tensile stress on the first waveguide and a compressive stress on the second waveguide;
wherein a first light beam of the one or more light beams traveling through the first waveguide undergoes a phase delay due to the tensile stress; and
wherein a second light beam of the one or more light beams traveling through the second waveguide undergoes a phase forward due to the compressive stress.

9. The gyroscope according to claim 8,
wherein the rotation of the gyroscope is determined based on a phase difference between the first light beam and the second light beam.

10. The gyroscope according to claim 9,
wherein the phase difference between the first light beam and the second light beam is determined by determining an intensity of an interference light beam generated by an interference of the first light beam and the second light beam.

11. The gyroscope according to any claim 1, further comprising:
a ring resonator that is optically coupled between the light source and the optical detector.

12. The gyroscope according to claim 11,
wherein the stress on the piezoelectric substrate causes a change in effective refractive index of the ring resonator, thus changing an intensity of the one or more light beams passing from the light source to the optical detector through the ring resonator.

13. The gyroscope according to claim 12,
wherein the rotation of the gyroscope is determined by the change in the intensity.

14. The gyroscope according to claim 1,
wherein the excitation transducer comprises a first interdigitated electrode; and
wherein the sensing transducer comprises a second interdigitated electrode.

15. The gyroscope according to claim 1,
wherein the light source is a laser source.

16. A method of forming a gyroscope, the method comprising:
forming an excitation transducer over a piezoelectric substrate, the excitation transducer configured to generate a surface acoustic wave;
forming a sensing transducer over the piezoelectric substrate, the sensing transducer configured to receive the surface acoustic wave generated by the excitation transducer;
forming a mass dot array over the piezoelectric substrate and between the excitation transducer and the sensing transducer, the mass dot array configured to generate a stress on the piezoelectric substrate based on a rotation of said gyroscope upon the surface acoustic wave passing through the mass dot array; and
coupling an optical detector to a light source;
wherein the optical detector is configured to receive one or more light beams generated by the light source to determine the rotation of the gyroscope based on a property of the one or more light beams; and
wherein the property of the one or more light beams is variable based on the stress on the piezoelectric substrate.

17. A method of operating a gyroscope, the method comprising
using an excitation transducer over a piezoelectric transducer to generate a surface acoustic wave so that the surface acoustic wave is received by a sensing transducer over the piezoelectric substrate, wherein the surface acoustic wave passes through a mass dot array, the mass dot array between the excitation transducer and the sensing transducer and over the piezoelectric substrate;
rotating the gyroscope so that the array generates a stress on the piezoelectric substrate based on said rotation of the gyroscope upon the surface acoustic wave passing through the mass dot array; and
determining the rotation of the gyroscope based on a property of one or more light beams received by an optical detector over the piezoelectric substrate, the optical detector optically coupled to a light source over the piezoelectric substrate;
wherein the property of the one or more light beams is variable based on the stress on the piezoelectric substrate.

18. The method according to claim 17,
wherein the mass dot array is configured to generate a secondary wave, the secondary wave orthogonal to the surface acoustic wave passing through the mass dot array, based on a Coriolis force acting on the mass dot array due to the rotation of the gyroscope.

19. The method according to claim 18,
wherein an axis along which the gyroscope is rotated is orthogonal to both the surface acoustic wave and the secondary wave.

20. The method according to claim 17,
wherein the property is an intensity of the one or more light beams.
